(19) United States
(12) Patent Application Publication
(10) Pub. No.: US 2009/0298995 A1
(43) Pub. Date: Dec. 3, 2009

(54) ADHESIVE FOR REVERSIBLE, UV-STABLE PSA TAPES

(75) Inventor: THORSTEN KRAWINKEL, HAMBURG (DE)

Correspondence Address: NORRIS, MCLAUGHLIN & MARCUS, PA, 875 THIRD AVENUE, 18TH FLOOR, NEW YORK, NY, 10022, US

(73) Assignee: TESA SE, Hamburg (DE)

(21) Appl. No.: 12/506,655

(22) Filed: Jul. 21, 2009

(30) Foreign Application Priority Data
Jul. 23, 2007 (DE) 10 2008 034 369.2

(51) Int. Cl. C08L 53/02; C08L 53/00

(52) U.S. Cl. 524/505; 525/89

(57) ABSTRACT

Adhesive for a pressure-sensitive adhesive tape, composed of
at least one block copolymer P1 having one or more terminal blocks composed of vinylaromatics and at least one block composed of conjugated dienes, in which more than 80% of the terminal double bonds, formed by 1,2-linkage, are hydrogenated, while less than 30% of the double bonds in the main chain, formed by 1,4-linkage, are hydrogenated, and
at least one block copolymer P2 having one or more terminal blocks composed of vinylaromatics and at least one block composed of conjugated dienes, in which at least 95% of the double bonds are hydrogenated.

The invention relates to a pressure-sensitive adhesive (PSA) based on vinylaromatic block copolymers which can be used in particular for redetachable, UV-stable adhesive tapes.

There have been diverse descriptions of single-sided or double-sided adhesive tapes which can be employed in sectors including the exterior sector.

For this sector it is customary to use either UV-impermeable carriers or adhesives which are stable towards UV light. In the former case, the UV light can always still attack the adhesive at the edges of the adhesive tape and lead there to instances of damage to the adhesive. Then, when the adhesive tape is redetached, unwanted residues frequently remain on the substrate.

UV-stable adhesives employed are primarily acrylates, compositions based on silicones or polyisobutylene. All of these adhesives have their specific disadvantages.

Acrylate adhesives are very good in terms of UV resistance, but possess very different bond strengths on different substrates. Whereas the bond strength on polar substrates such as glass or metal is very high, the bond strength on apolar substrates such as polyethylene or polypropylene, for example, is fairly low.

Silicone adhesives are excellently suited to reversible exterior applications, but their high price dramatically limits the possible fields of use, and for that reason they are employed only for very specific tasks.

Adhesives based on polyisobutylene have a decidedly low cohesion, and so frequently leave residues of adhesive on the substrate when being redetached.

Other adhesives, such as those based on natural rubber, are not suitable, since they are severely damaged by the UV light. Although some improvement can be provided here through the use of fillers and UV absorbers, the UV resistance nevertheless remains inadequate in the majority of cases.

Adhesives based on vinylaromatic block copolymers have proved to be advantageous when the bonding in question is to apolar substrates. These adhesives have the advantage of possessing a similar bond strength on different substrates and exhibiting only moderate peel increase on the substrate, thereby allowing post-use redetachment even after a relatively long period of bonding, if the bond strength formulated is not too high.

As a result of the double bonds that are present in the vinylaromatic block copolymers based on SIS (styrene-isoprene-styrene) and SBS (styrene-butadiene-styrene) that are principally employed, adhesives on this basis are not stable to ageing.

It is indeed possible to admix the PSAs used with ageing inhibitors in the form, for example, of primary antioxidants, secondary antioxidants, C radical scavengers, light stabilizers such as UV absorbers, for example, sterically hindered amines, or additives which scatter or reflect the harmful electromagnetic radiation, in the form for example of fillers and/or colour pigments, and yet the effect of such additives is normally only a gradual improvement in the ageing stability, meaning that ageing processes can be delayed for a limited time only.

In comparison to polymers based on unsaturated hydrocarbons, however, the ageing stability achieved, in particular the UV stability realized, remains low.

One possibility for increasing the ageing resistance and particularly the UV stability when using vinylaromatic block copolymers lies in the use of vinylaromatic block copolymers which are hydrogenated in the elastomer block, as is the case, for example, in styrene-ethylene/butylene-styrene block copolymers (SEBS; obtained by hydrogenation of SBS) and/or styrene-ethylene/propylene-styrene block copolymers (SEPS; obtained by hydrogenation of SIS).

A disadvantage of the use of corresponding vinylaromatic block copolymers hydrogenated in the elastomer block, however, is that experience indicates that the bond strengths realizable therewith are significantly below those which are achieved with the analogous styrene-butadiene-styrene and styrene-isoprene-styrene block copolymers without hydrogenation in the elastomer block. The initial tack in particular is decidedly low. Besides the subjective perception of the user, that an adhesive tape with a low initial tack is also unable to provide proper sticking, the bonding of adhesive tapes featuring such PSAs to rough substrates, such as those frequently encountered in the exterior sector, is inadequate. An improvement through the use of very soft elastomers with a low vinylaromatic content and a high diblock content leads to adhesives which even at moderate temperatures of 50 to 60° C. exhibit a significant loss of cohesion and a propensity to fail.

Improvements are provided here by vinylaromatic block copolymers having a high fraction of 1,2-linked diene, in which the 1,2-linked double bonds have been hydrogenated, while the double bonds in the polymer chain are retained. These polymers, available for example from Asahi Chemicals under the trade name Tuftec P, exhibit a significantly improved UV stability and ageing stability by comparison with non-hydrogenated vinylaromatic block copolymers, but also at the same time, given suitable blending with tackifier resins, they exhibit an improved initial tack as compared with fully hydrogenated block copolymers. Moreover, there is a significant increase in the compatibility with a series of tackifier resins as compared with fully hydrogenated block copolymers.

In spite of the improvement in the ageing stability and UV stability of such systems, there are still double bonds in the main chain of the polymer that can react with UV light. The desire is for a further improvement in ageing stability beyond the performance of the stated partly hydrogenated block copolymers.

It is an object of the invention, therefore, to find a reversible adhesive with high resistance to UV light whose bond strengths on different substrates are similar to those of the known adhesives.

This object is achieved by an adhesive as recorded in the main claim. The dependent claims provide advantageous developments of the adhesive and also provide for the use of the adhesive for forming a pressure-sensitive adhesive tape.

Adhesives based on mixtures of partly hydrogenated block copolymers and fully hydrogenated polymers are very suitable, surprisingly, for the stated application. The adhesives exhibit sufficient stability towards UV light but still have sufficient bond strength and initial tack to be able to be used on rough and apolar substrates as well.

The invention accordingly provides an adhesive for a pressure-sensitive adhesive tape, composed of
at least one block copolymer P1 having one or more terminal blocks composed of vinylaromatics and at least one block composed of conjugated dienes, in which more than 80% of the terminal double bonds, formed by 1,2-linkage, are hydrogenated, while less than 30% of the double bonds in the main chain, formed by 1,4-linkage, are hydrogenated, and
at least one block copolymer P2 having one or more terminal blocks composed of vinylaromatics and at least one block composed of conjugated dienes, in which at least 95% of the double bonds are hydrogenated.

In a first advantageous embodiment the block copolymers have a polyvinylaromatic fraction of 10% to 35% by weight.

In a further advantageous embodiment the fraction of the two vinylaromatic block copolymers in total, based on the overall adhesive, is 20% to 70%, preferably 30% to 60%, more preferably 35% to 55% by weight.

In the preparation of block copolymers based on vinylaromatics, preferably styrene and 1,3-dienes, particularly isoprene and butadiene, the dienes in the diene block are incorporated with both 1,2- and 1,4-linkage. The fraction of 1,2-linked dienes can be controlled through the solvent, the temperature or the catalyst. Since the 1,2-linked dienes contain a terminal double bond, whereas in the case of the 1,4-linked dienes the double bond is in the main chain, it is possible to carry out selective hydrogenation of the terminal—and hence more reactive—double bonds.

Block copolymers employed are those which possess, firstly, blocks of vinylaromatics (A blocks) such as, for example styrene, and which, secondly, possess blocks formed by polymerization of 1,3-dienes (B blocks) such as, for example, butadiene and isoprene or a mixture of the two. The B blocks are polymerized in such a way that they possess a high fraction of vinyl groups, as a result of 1,2-linkage, of more than 20%, which are hydrogenated, in contrast to the double bonds in the main chain. When the non-hydrogenated block copolymer is an SBS, the product after the selective hydrogenation is known as an SBBS (styrene-butadiene/butylene-styrene). Since the selectivity of the hydrogenation is not 100%, it is possible to employ block copolymers more than 80% of whose vinylic double bonds, formed by 1,2-linkage, are hydrogenated, while only 30% at most of the double bonds in the main chain are hydrogenated.

As a second component, block copolymers are employed which possess, firstly, blocks of vinylaromatics (A blocks) such as, for example, styrene, and which possess, secondly, blocks formed by polymerization of 1,3-dienes (B blocks) such as, for example, butadiene and isoprene or a mixture of the two, a fraction of more than 95% of the overall double bonds in the B blocks being hydrogenated.

The block copolymers may have a linear A-B-A structure. It is likewise possible to employ block copolymers of radial design and also star-shaped and linear multiblock copolymers. As a further component it is possible to use A-B diblock copolymers.

In place of the preferred polystyrene blocks it is also possible to utilize polymer blocks based on other aromatics-containing homopolymers and copolymers (preferably C₈ to C₁₂ aromatics) having glass transition temperatures of greater than about 75° C., such as aromatics blocks containing α-methylstyrene, for example.

The two elastomers, one—P1—partly hydrogenated and the other—P2 —hydrogenated to an extent of at least 95%, are present in accordance with the invention in a ratio (weight fractions) of 25:75 up to a ratio of 90:10, preferably in the range of 40:60 and 80:20.

Serving as tackifiers are tackifier resins which are compatible with the elastomer block of the vinylaromatic block copolymers. Suitable tackifier resins include among others, preferably, non-hydrogenated, partially hydrogenated or fully hydrogenated resins based on rosin or on rosin derivatives, hydrogenated polymers of dicyclopentadiene, non-hydrogenated or partially, selectively or fully hydrogenated hydrocarbon resins based on C₅, C₅/C₉ or C₉ monomer streams, or polyterpene resins based on α-pinene and/or β-pinene and/or δ-limonene. The aforementioned tackifier resins may be used both alone and in a mixture.

In this context it is possible for resins which are solid at room temperature and also resins which are liquid to be used.

In order to ensure high ageing stability and UV stability, hydrogenated resins are preferred.

Further additives which can typically be utilized are as follows:
plasticizers such as, for example, plasticizer oils or low molecular mass liquid polymers such as, for example, low molecular mass polybutenes
primary antioxidants such as, for example, sterically hindered phenols
secondary antioxidants such as, for example, phosphites or thioethers
in-process stabilizers such as, for example, C radical scavengers
light stabilizers such as, for example, UV-absorbers or sterically hindered amines
fillers such as fibres, carbon black, zinc oxide, titanium dioxide, solid microbeads, solid or hollow glass beads, silica, silicates, chalk
processing assistants,
endblock reinforcer resins and
optionally, further polymers, preferably elastomeric in nature; elastomers which can be utilized accordingly include, among others, those based on pure hydrocarbons, such as, for example, unsaturated polydienes, such as natural or synthetic polyisoprene or polybutadiene, elastomers with substantial chemical saturation such as, for example, saturated ethylene-propylene copolymers, α-olefin copolymers, polyisobutylene, butyl rubber, ethylene-propylene rubber, and also chemically functionalized hydrocarbons such as, for example, halogen-containing, acrylate-containing or vinyl ether-containing polyolefins, to name but a few.

It is also in accordance with the invention if the adhesive does not have all of the stated adjuvants in each case.

The adhesives described may be employed both in single-sided and in double-sided adhesive tapes. In this context it is possible, for the various applications, to combine a wide variety of different carriers such as, for example, films, woven fabrics, nonwovens and papers, with the adhesives.

The general expression “adhesive tape” encompasses, for the purposes of this invention, all sheet-like structures such as two-dimensionally extended films or film sections, tapes with extended length and limited width, tape sections and the like, and also, lastly, diecuts or labels.

### Preparation of the PSAs

The preparation and processing of the pressure-sensitive adhesives (PSAs) may take place from solution, from dispersion, and from the melt. Preferred preparation and processing processes are from solution and from the melt. Particular preference is given to the manufacture of the adhesive from the melt, in which case it is possible more particularly to employ batch methods or continuous methods. The continuous manufacture of the PSAs by means of an extruder is especially advantageous.

The PSAs thus prepared can then be applied to the carrier by the methods that are general knowledge. In the case of processing from the melt, this may be application methods via a die or a calender.

In the case of methods from solution, coating operations with blades, knifes or nozzles are known, to name but a few.

The invention is illustrated below in more detail by a number of examples, without any intention that the invention should be restricted by these examples.

### EXAMPLES

### Test Methods

### Bond Strength

The determination of the bond strength was carried out as follows: the defined substrates were a steel surface, a polyethylene surface (PE) and a 300-grade sandpaper. The bondable planar element under investigation was cut to a width of 20 mm and a length of about 25 cm, provided with a section for handling, and immediately thereafter pressed onto each selected substrate five times using a 4 kg steel roller at a speed of 10 m/min. Immediately after that, the bondable planar element was peeled from the substrate with a tensile testing instrument (from Zwick) at an angle of 180°, and the force required to achieve this at room temperature was recorded. The measurement value (in N/cm) resulted as the average value from three individual measurements.

Moreover, the same test was carried out after storage of the bonded samples at 40° C. for 3 days, followed by their conditioning to room temperature and then by measurement as described above.

### Tack

The tack was determined by the rolling ball method, in which a steel ball with a dimension of 11 mm rolls onto the adhesive side of the adhesive tape from a ramp at a height of 65 mm. The distance traveled is a measure of the initial tack. The lower this distance, the higher the tack.

### UV Test

For the measurement of UV stability, the samples, in a width of 20 mm and a length of 25 cm, are bonded to a glass plate with a thickness of 4 mm and rolled on five times using a 2 kg roller.

15 specimens were produced in this way for each example.

The specimens were stored, with the glass side upwards, in a UV chamber with a xenon lamp, with an irradiance of 500 W/m². Each day, one of the strips per example was taken from the UV chamber and, after conditioning to room temperature for 1 h, was peeled from the glass plate.

In this procedure a record was made of whether there were residues of adhesive on the glass plate.

All of the examples were admixed with, as ageing inhibitor, 0.5 part of Irganox 1010 and 0.5 part of Tinuvin P as UV absorber.

### Comparative Example C1

| | | |
|---|---|---|
| 100 parts | Vector 4113 | SIS with15% block polystyrene content and |
| | | about 20% diblock content, from Dexco |
| 100 parts | Escorez 5600 | Hydrogenated HC resin with a softening |
| | | point of 100° C., from Exxon |
| 25 parts | Ondina G 17 | White oil comprising paraffinic and |
| | | naphthenic fractions, from Shell |

### Comparative Example C2

| | | |
|---|---|---|
| 100 parts | Kraton G 1657 | SEBS with 13% block polystyrene content |
| | | and about 36% diblock content, from Kraton |
| 100 parts | Escorez 5600 | Hydrogenated HC resin with a softening |
| | | point of 100° C., from Exxon |
| 25 parts | Ondina G 17 | White oil comprising paraffinic and |
| | | naphthenic fractions, from Shell |

### Comparative Example C3

| | | |
|---|---|---|
| 100 parts | Tuftec P 1500 | SBBS with 30% block polystyrene content |
| | | and about 68% diblock content, from Asahi |
| 100 parts | Escorez 5600 | Hydrogenated HC resin with a softening |
| | | point of 100° C., from Exxon |
| 25 parts | Ondina G 17 | White oil comprising paraffinic and |
| | | naphthenic fractions, from Shell |

### Inventive Example 4

| | | |
|---|---|---|
| 70 parts | Tuftec P 1500 | SBBS with 30% block polystyrene content |
| | | and about 68% diblock content, from Asahi |
| 30 parts | Kraton G 1657 | SEBS with 13% block polystyrene content |
| | | and about 36% diblock content, from Kraton |
| 100 parts | Escorez 5600 | Hydrogenated HC resin with a softening |
| | | point of 100° C., from Exxon |
| 25 parts | Ondina G 17 | White oil comprising paraffinic and |
| | | naphthenic fractions, from Shell |

### Production of the Specimens

The PSAs were prepared from solution for the examples. This was done by dissolving the individual constituents in toluene (solids fraction 40%) and coating out the solution onto an untreated PET film, with drying at 120° C. for 15 minutes, in such a way as to produce a layer of adhesive having a weight per unit area of 60 g/m².

| | Bond | | | | | | | |
|---|---|---|---|---|---|---|---|---|
| | strength | | Bond | | Bond strength | | | |
| | to steel | | strength to PE | | to sandpaper in | | | |
| | in N/cm | | in N/cm | | N/cm | | | |
| | | After 3 | | After 3 | | After 3 | | |
| PSA of | | days at | | days at | | days at | Tack | Redetachability |
| Example | Fresh | 40° C. | Fresh | 40° C. | Fresh | 40° C. | in mm | after UV storage |
| C1 | 10.7 | 12.9 | 6.8 | 8.3 | 1.6 | 3.1 | 25 | Residues over |
| | | | | | | | | full area |
| | | | | | | | | after 3 days |
| C2 | 4.2 | 5.6 | 3.6 | 4.3 | 0.5 | 1.1 | >300 | No residues |
| | | | | | | | | after 15 days |
| C3 | 7.3 | 8.3 | 5.1 | 6.6 | 1.2 | 2.5 | 92 | Residues at |
| | | | | | | | | the edge |
| | | | | | | | | after 13 days |
| 4 | 6.5 | 7.4 | 4.4 | 5.7 | 1.2 | 2.1 | 112 | No residues |
| | | | | | | | | after 15 days |

As expected, the UV stability in the case of specimens with SIS (C1) is very low, and so after just a few days there are residues of adhesive in the UV test. The situation is different with the hydrogenated elastomers. However, even if the pure SBBS adhesives (C3) also show certain weaknesses here. Adhesives based on SEBS (C2) have a very low tack and a poor adhesion to rough substrates.

In contrast, the properties are particularly well balanced in the case of a mixture of SBBS and SEBS (4), and so such adhesives can be used for reversible adhesive bonds even under UV light.

1. An adhesive composition for a pressure-sensitive adhesive tape, said adhesive composition comprising
(a) a first block copolymer, P1, having one or more terminal blocks comprising vinylaromatics and at least one block comprising conjugated dienes, in which more than 80% of the terminal double bonds, formed by 1,2-linkage, are hydrogenated, while less than 30% of the double bonds in the main chain, formed by 1,4-linkage, are hydrogenated, and
(b) a second block copolymer, P2, having one or more terminal blocks comprising vinylaromatics and at least one block comprising conjugated dienes, in which at least 95% of the double bonds are hydrogenated.

2. The adhesive composition according to claim 1, wherein the vinylaromatics comprise styrene.

3. The adhesive composition according to claim 1, wherein the two block copolymers, P1 and P2, are present in a ratio of 25:75 up to 90:10 weight fractions.

4. The adhesive composition according to claim 2 wherein the block copolymer P1 is a partly hydrogenated styrene-butadiene-styrene block copolymer.

5. The adhesive composition according to claim 1, wherein, the polyvinylaromatic fraction of the block copolymers P1 and P2 is in each case between 10% and 35% by weight.

6. The adhesive composition according to claim 1 wherein, the fraction of the two vinylaromatic block copolymers in total, based on the overall adhesive, is 20% to 70%.

8. The adhesive composition according to claim 1 wherein, the adhesive additionally comprises tackifier resins.

9. The adhesive composition according to claim 1 wherein, the adhesive comprises at least one UV protectant.

10. The adhesive composition according to claim 1 wherein, the adhesive comprises further blend components, selected from the group consisting of plasticizers, ageing inhibitors, processing assistants, fillers, dyes, optical brighteners, stabilizers, and endblock reinforcer resins.

11. (canceled)

12. The adhesive composition according to claim 3 wherein the two block copolymers are present in a ratio of 40:60 weight fraction.

13. The adhesive composition according to claim 12 wherein the two block copolymers are present in a ratio of 80:20 weight fraction.

14. The adhesive composition according to claim 6 wherein the fraction of the two vinylaromatic block copolymers in total, based on the overall adhesive, is 30% to 60% by weight.

15. The adhesive composition according to claim 14 wherein the fraction of the two vinylaromatic block copolymers in total, based on the overall adhesive, is 35% to 55% by weight.
